(19) United States
(12) Patent Application Publication
(10) Pub. No.: US 2014/0245236 A1
(43) Pub. Date: Aug. 28, 2014

(54) Data Processing Apparatus Which Detects Gesture Operation

(71) Applicant: CASIO COMPUTER CO., LTD., Tokyo (JP)

(72) Inventor: Satoshi Kimura, Ome-shi (JP)

(73) Assignee: CASIO COMPUTER CO., LTD., Tokyo (JP)

(21) Appl. No.: 14/191,319

(22) Filed: Feb. 26, 2014

(30) Foreign Application Priority Data
Feb. 27, 2013 (JP) 2013-037594

(51) Int. Cl. G06F 3/01

(52) U.S. Cl. CPC G06F 3/017
USPC 715/863

(57) ABSTRACT

An object of the present invention is to appropriately judge a gesture operation when the gesture operation is detected and data processing is performed in accordance with the gesture operation. A gesture operation is detected, and gesture operation types are narrowed down based on the detection result. Also, by referring to a user information table including user attributes of an operator performing the gesture operation, the gesture operation types are narrowed down to one gesture operation type.

### CROSS-REFERENCE TO RELATED APPLICATION

This application is based upon and claims the benefit of priority from the prior Japanese Patent Application No. 2013-037594, filed Feb. 27, 2013, the entire contents of which are incorporated herein by reference.

### BACKGROUND OF THE INVENTION

1. Field of the Invention

The present invention relates to a data processing apparatus which detects a gesture operation and performs data processing in accordance with a type of the gesture operation.

2. Description of the Related Art

Conventionally, there has been known a technology of judging which type of operation has been performed based on the movement itself of a gesture operation on a touch panel in a data processing apparatus such as a mobile terminal device. For example, there have been known a technology of judging whether a flick operation or a tap operation has been performed based on the relation between a contact start point and a contact endpoint on the touch panel (refer to Japanese Patent Application Laid-Open (Kokai) Publication No. 2011-118629), a technology of judging whether a drag operation or a flick operation has been performed based on a threshold regarding a touch position distribution state (refer to Japanese Patent Application Laid-Open (Kokai) Publication No. 2011-134212), and a technology of judging whether a flick operation has been performed based on a judgment of thresholds regarding the movement and speed of the operation (refer to Japanese Patent Application Laid-Open (Kokai) Publication No. 2006-085703).

However, in each of the above-described technologies, it is merely judged whether a flick operation has been performed based on the movement of the gesture operation itself (based on the physical operation status), and therefore there is danger of an erroneous judgment.

That is, even if the users intend to perform the same type of gesture operation, the movements of the gesture operation performed by the users may be slightly different from each other. As a result, a gesture judgment not intended by the user may be made. For example, an operation may be erroneously judged as a tap operation even though the user has intended to perform a flick operation, or may be erroneously judged as a flick operation even though the user has intended to perform a tap operation.

### SUMMARY OF THE INVENTION

An object of the present invention is to appropriately judge a gesture operation when the gesture operation is detected and data processing is performed in accordance with the gesture operation.

The present invention has a below configuration. A data processing apparatus which detects a gesture operation, the apparatus comprising: an attribute storage section which stores an attribute of a user; a detecting section which detects an operation content of the gesture operation; a judging section which judges, when the gesture operation is performed, a type of the gesture operation performed from among a plurality of gesture operation types based on a detection result of the operation content detected by the detecting section and the user attribute stored in the attribute storage section; and a data processing section which performs processing of a type in accordance with the gesture operation type judged by the judging section.

According to the present invention, when a gesture operation is detected and data processing is performed in accordance with the gesture operation, the gesture operation can be appropriately judged, and thereby operability is improved.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram depicting basic components of a tablet terminal device to which the present invention is applied as a data processing apparatus;

FIG. 2 is a diagram of a thumbnail screen when various types of images are reduced for list display on a touch display section 6;

FIG. 3A is a diagram for describing a priority judgment table 3d;

FIG. 3B is a diagram for describing a user information table 3e;

FIG. 4 is a flowchart of an operation that is started when image display processing is specified;

FIG. 5 is a flowchart of an operation following the operation of FIG. 4; and

FIG. 6 is a flowchart of user's operation habit learning processing that is started every time a gesture operation is performed.

### DETAILED DESCRIPTION OF THE PREFERRED EMBODIMENTS

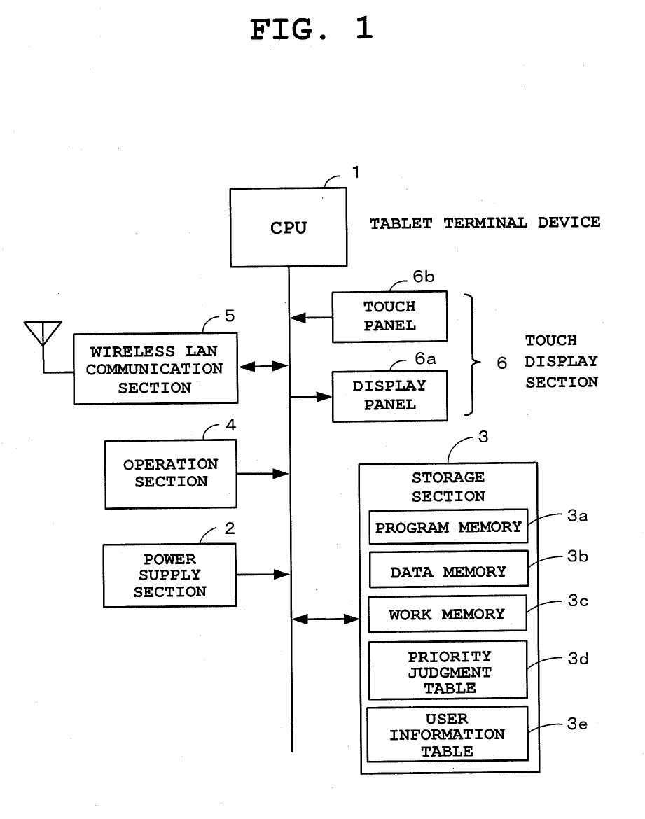

An embodiment of the present invention will hereinafter be described with reference to FIG. 1 to FIG. 6.

In the present embodiment, the present invention is applied to a tablet terminal device as a data processing apparatus. FIG. 1 is a block diagram depicting basic components of the tablet terminal device.

The tablet terminal device is, for example, a portable information terminal device of an A5 size as a whole, and includes a touch input function and a wireless communication function, etc. A CPU (Central Processing Unit) 1 operates by receiving power from a power supply section (secondary battery) 2 and controls the entire operation of this tablet terminal device in accordance with various programs in a storage section 3.

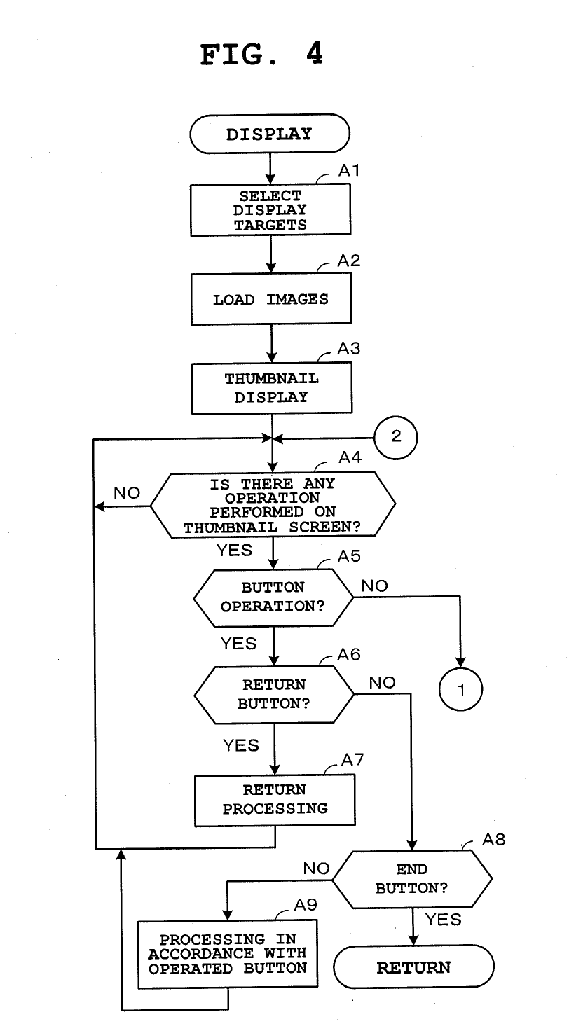

The storage section 3 is constituted by, for example, a ROM (Read-Only Memory) and a flash memory. The storage section 3 includes a program memory 3a which stores programs for achieving the present embodiment in accordance with operation procedures depicted in FIG. 4 to FIG. 6, a data memory 3b which stores various data (such as image data and text data) required in the tablet terminal device, and a work memory 3c which temporarily stores a flag or the like, as well as a priority judgment table 3d and a user information table 3e, which will be described further below.

Note that the storage section 3 may include, for example, a removable and transportable memory (recording medium) such as an SD (Secure Digital) card and an IC (Integrated Circuit) card. Although not shown, the storage section 3 may be configured to include a storage area on a predetermined server device side in a state where the storage section 3 is connected to a network by means of a communication function.

An operation section 4 includes, although not shown, a power key to turn the power supply ON/OFF as a push-button key. A wireless LAN (Local Area Network) communication section 5 is a wireless communication module that can perform high-speed and high-volume communication and can be connected to the Internet via a nearest wireless LAN router (not shown). A touch display section 6 is constituted such that a touch panel 6b is arranged to be laminated on a display panel 6a, which displays a function name as a software key (a soft key) and also displays various icons.

The touch panel 6b of the touch display section 6 constitutes a touch screen which detects a point where a touch operation has been performed with a finger of a user or the like (including an operator such as a pen) and inputs coordinate data of the point. Note that, although a capacitive type or a resistive film type is adopted in this embodiment, another type such as a light sensor type may be adopted.

When a touch operation (hereinafter, various types of touch operations may be collectively referred to as gesture operations) is performed on the touch display section 6, the CPU 1 detects a moving direction, moving speed, and moving amount of the finger or the like based on a temporal change of a signal corresponding to a contact position, and detects that a contact with the finger or the like has been lost. The CPU 1 then judges a gesture operation type on the touch panel 6b, and performs data processing in accordance with the type.

That is, the CPU 1 judges whether a gesture operation indicating a position in a screen of the touch display section 6 has been performed, or a gesture operation for instructing a change of display contents in the screen has been performed, as the content (type) of the gesture operation.

Here, in the present embodiment, as a gesture operation type performed on the touch panel 6b, it is judged whether a gesture operation of making contact with any position on the touch panel 6b and then immediately releasing therefrom (a tap operation) or a gesture operation of making contact with and moving over the touch panel 6b and then immediately releasing therefrom (a flick operation for instructing a display scroll) has been performed. The gesture operations are not limited to these tap operation and flick operation, and another type of gesture operation may be judged from among a plurality of gesture operations.

Note that the gesture operations are not limited to contact operations (touch operations) on the touch panel 6b, but are intended to include, as an operation similar to a contact operation, a non-contact operation for which the position of a finger or a pen is detected based on changes in capacitance or brightness by the approach or the approach and movement of the finger or the pen.

That is, the touch panel 6b is not limited to a contact-type touch panel which detects a contact operation, and may be a non-contact-type touch panel or operation detection device which detects a non-contact operation. In the present embodiment, as a gesture operation, a contact operation on a contact-type touch panel is exemplarily described.

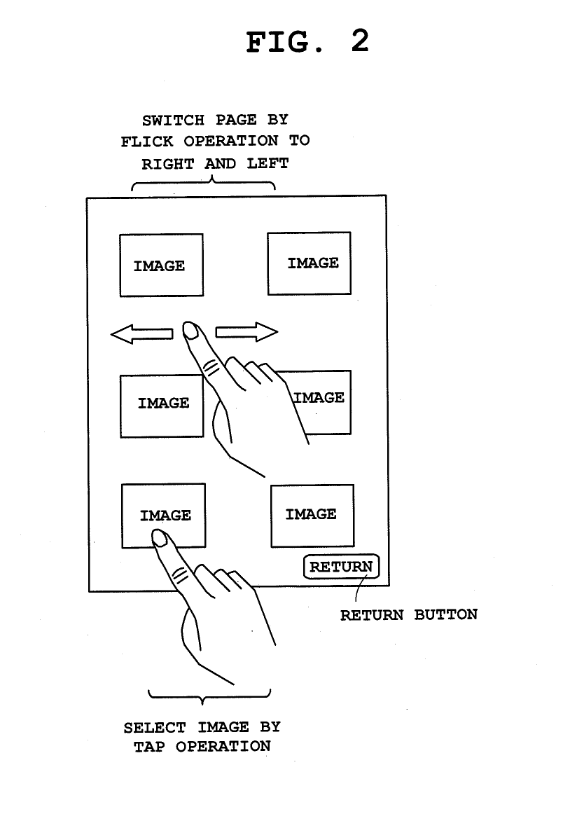

FIG. 2 is a diagram of a thumbnail screen when various types of images are reduced for list display on the touch display section 6.

When image display is specified by a user operation, the CPU 1 causes images supplied from an outside source such as an SD card, to be displayed as a list on the thumbnail screen. In the example of FIG. 2, a plurality of images are arranged and displayed in a matrix of three rows and two columns on the thumbnail screen.

In a vacant area in the thumbnail screen, various buttons are arranged. For example, in a lower-right area, a return button is arranged for instructing to cancel the immediately preceding operation and return to an original status. Other than the return button, another example of the buttons arranged on the thumbnail screen is a page switch button (not shown).

When any gesture operation is performed on the thumbnail screen, the CPU 1 judges a type of the gesture operation (gesture operation type). When the gesture operation type is a tap operation, the CPU 1 performs image selection processing. When the gesture operation type is a flick operation, the CPU 1 performs page switch processing.

In the example of FIG. 2, a tap operation is performed on an image on a third row and a first column, and a flick operation in the direction indicated by a right arrow and a flick operation in the direction indicated by a left arrow are performed in a vacant area between a first row and a second row.

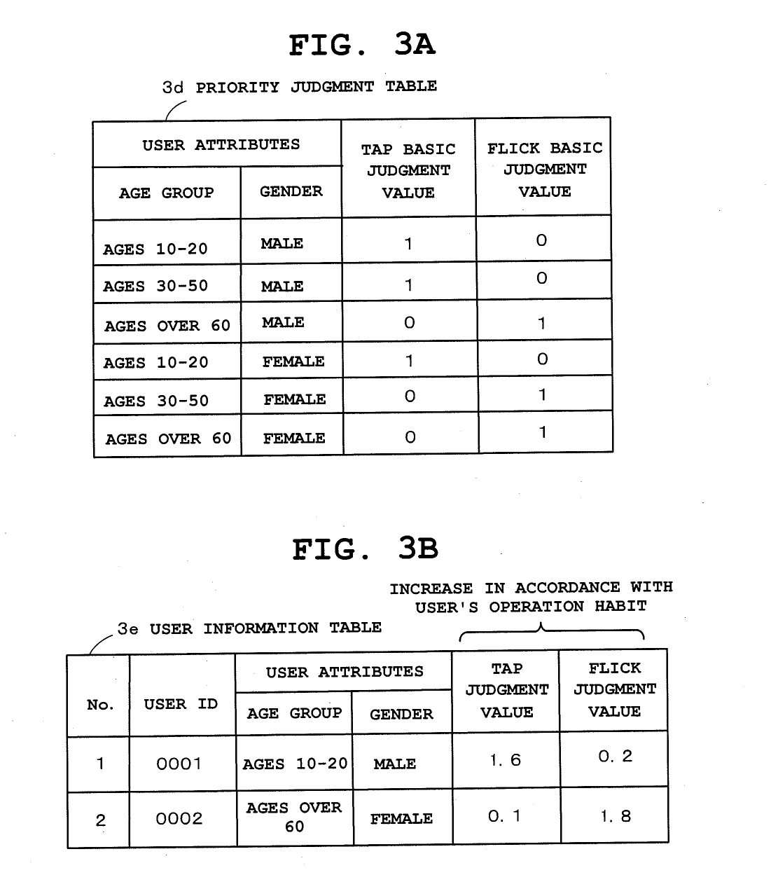

FIG. 3A is a diagram for describing the priority judgment table 3d, and FIG. 3B is a diagram for describing the user information table 3e.

The priority judgment table 3d of FIG. 3A is, for example, a table prepared in advance at the time of product shipping, and includes items such as “user attributes”, “tap basic judgment value”, and “flick basic judgment value”.

“User attributes” includes items of “age group” and “gender” indicating attributes of operators (users), and is classified into “ages 10-20”, “ages 30-50”, . . . , “ages over 60” as age groups by gender.

“Tap basic judgment value” and “flick basic judgment value” are judgment values referenced when judging a gesture operation type and fixedly (basically) set in advance in accordance with the user attributes.

For example, in general, males at “ages 10-20” and “ages 30-50” tend to powerfully perform a flick operation, and thereby have characteristics that their values of the moving speed and the moving amount are large. However, these males also tend to powerfully perform a tap operation. As a result, it may be difficult in some cases to narrow down the gesture operation types to one.

In this case, in the example of FIG. 3A, “1” is set as “tap basic judgment value” and “0” is set as “flick basic judgment value” so as to prioritize the tap operation. By contrast, males at “ages over 60” tend to gently and slowly perform a flick operation, and thereby their values of moving speed and moving amount are small. However, they also tend to gently perform a tap operation. In this case, in the example of FIG. 3A, “0” is set as “tap basic judgment value” and “1” is set as “flick basic judgment value” so as to prioritize a flick operation for judgment.

For females at “ages 10-20”, “1” is set as “tap basic judgment value” and “0” is set as “flick basic judgment value”. For females at “ages 30-50” and “ages over 60”, “0” is set as “tap basic judgment value” and “1” is set as “flick basic judgment value”.

In the above-described example, “0” or “1” is set as “tap basic judgment value” and “flick basic judgment value”, whereby “1” indicates priority and “0” indicates non-priority. However, the present invention is not limited thereto. For example, a numerical value equal to or smaller than “10” may be set.

FIG. 3B is a diagram for describing the user information table 3e.

The user information table 3e stores therein, for each user, items of “No.”, “user ID”, “user attributes”, “tap judgment value” and “flick judgment value” as information regarding the user. Accordingly, even in an environment where a plurality of users share the tablet terminal device for use, each user can set his or her own identification information in “user ID”. Furthermore, when he or she selects and specifies user attributes (corresponding to his or her own age group or gender) from the priority judgment table 3d, the “age group” and “gender” included in the selected-and-specified user attributes are set as “user attributes” in the user information table 3e.

And then, “tap basic judgment value” and “flick basic judgment value” corresponding to the selected-and-specified user attributes set as “user attributes” are read out from the priority judgment table 3d, and the read out tap basic judgment value and flick basic judgment value are set as the corresponding “tap judgment value” and “flick judgment value” in the user information table 3e as initial values.

The values of these “tap judgment value” and “flick judgment value” are increased from initial values in accordance with the operation habit of the user. That is, the CPU 1 learns the operation habit of the user regarding the tap operation and flick operation and increases the values of the “tap judgment value” and “flick judgment value” based on the learning result.

Here, when a return operation in an opposite direction (a reverse-flick operation) or the return button (refer to FIG. 2) is operated immediately after a flick operation (for example, within one second after), and then a tap operation is further performed, the CPU 1 judges that the tap operation has been erroneously judged as a flick operation, and increases the value of “tap judgment value” (for example, increased by 0.1). When the return button (refer to FIG. 2) is operated immediately after a tap operation (for example, within one second after), and then a flick operation is further performed, the CPU 1 judges that the flick operation has been erroneously judged as a tap operation and increases the value of “tap judgment value” (for example, increased by 0.1).

As such, in the present embodiment, the data processing apparatus (tablet terminal device) includes an attribute storage section (the user information table 3e and the CPU 1) which stores user attributes (gender, age group, and operation habit); a detection section (the CPU 1 and the touch display section 6) which detects a gesture operation; a judgment section (the CPU 1) which judges, when a gesture operation is performed, a gesture operation type operated from among a plurality of gesture operation types, based on the detection result of this detection section and the user attributes stored in the attribute storage section; and a data processing section (the CPU 1) which performs processing of a type in accordance with the gesture operation type judged by the judgment section.

Next, the operational concept of the data processing apparatus (tablet terminal device) in the present embodiment is described with reference to flowcharts depicted in FIG. 4 to FIG. 6.

Here, each function described in these flowcharts is stored in readable program code format, and operations based on these program codes are sequentially performed. Also, operations based on the above-described program code transmitted over a transmission medium such as a network can also be sequentially performed. That is, the unique operations of the present embodiment can be performed using programs and data supplied from an outside source over a transmission medium, in addition to a recording medium. Note that FIG. 4 to FIG. 6 are the flowcharts outlining the operation of a characteristic portion of the present embodiment, from among all of the operations of the tablet terminal device. After exiting the flows of FIG. 4 to FIG. 6, the process is returned to the main flow (not shown) of the entire operations.

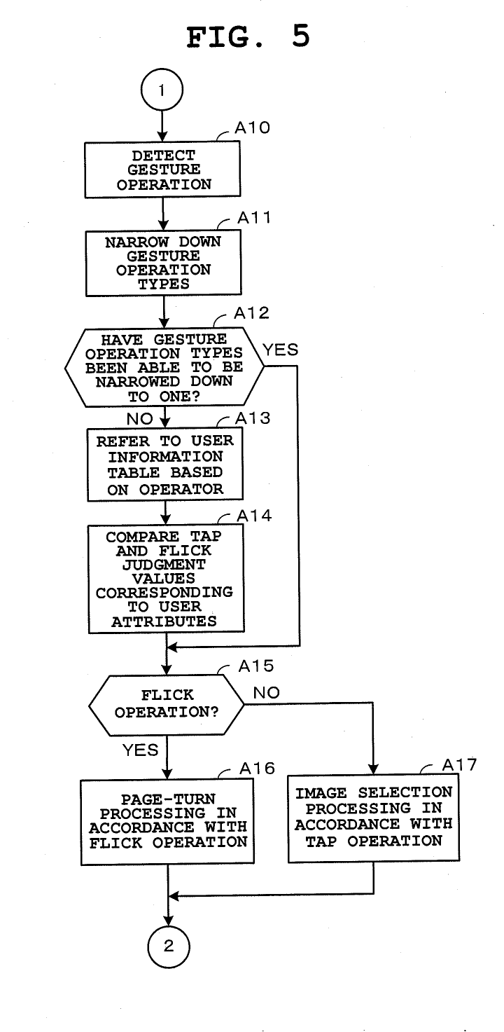

FIG. 4 and FIG. 5 is a flowchart of an operation that is started when image display processing is specified. It is assumed that, prior to this image display processing, an operator (user) is specified based on user information or biological information inputted when power supply is turned ON.

First, the CPU 1 selects various images supplied from an outside source such as an SD card, as display targets (Step A1 of FIG. 4), loads these images (Step A2), performs reduction processing, and then causes the reduced images to be displayed as thumbnails on the touch display section 6 (Step A3).

On the thumbnail screen, a plurality of images are arranged and displayed in a matrix of three rows and two columns, and a return button and the like are arranged, as depicted in FIG. 2, for example. When any operation is performed on this thumbnail screen (YES at Step A4), the CPU 1 judges whether the operation is performed by a button operation such as the return button or the like (Step A5). When the operation is performed by a button operation (YES at Step A5), the CPU 1 judges whether the operated button is the return button (Step A6), and judges whether the operated button is an end button for instructing to end the image display processing (Step A8).

Here, when the return button is operated (YES at Step A6), the CPU 1 performs a return processing of cancelling the immediately preceding operation and returning to an original status (Step A7), and then proceeds to Step A4 described above. When another button other than the return button and the end button is operated (NO at Step A8), the CPU 1 performs processing in accordance with the operated button (for example, page switch processing) (Step A9), and then proceeds to Step A4 described above.

Also, when the operated button is the end button (YES at Step A8), the CPU 1 causes the present process to exit the flows of FIG. 4 and FIG. 5. When the operation on the thumbnail screen is not a button operation, that is, when the operation is a gesture operation (NO at Step A5), the CPU 1 proceeds to the flow of FIG. 5.

First, when a gesture operation is performed on the thumbnail screen, the CPU 1 detects the gesture operation, by detecting a contact position on the touch panel 6b as well as by detecting a moving direction, moving speed, and moving amount of a finger or the like based on a temporal change of a signal corresponding to the contact position, and by detecting that the contact with the finger or the like has been lost (Step A10 of FIG. 5).

Then, at the subsequent Step A11, the CPU 1 narrows down the gesture operations based on the detection result of the gesture operation (narrow down to a tap operation or a flick operation), and thereby judges whether gesture operation types have been able to be narrowed down to one (Step A12).

In this case, for example, the CPU 1 judges whether the detection result (operation pattern) of the gesture operation is characteristically similar to respective operation patterns of a plurality of gesture operation types. When the operation pattern is not similar to two or more operation patterns among the operation patterns of the plurality of gesture operation types, that is, when the operation pattern is similar only to any one of the operation patterns of the gesture operation types, the CPU 1 judges that the gesture operation types have been able to be narrowed down to one.

Here, when a feature of a gesture operation type (operation pattern) is clearly detected, such as a powerful flick operation, based on the detection result (such as the moving direction, moving speed, or moving amount) of the gesture operation and the CPU 1 judges that the gesture operation types have been able to be narrowed down to one (YES at Step A12), the CPU 1 proceeds to the subsequent Step A15.

In this case, when the gesture operation type obtained by narrowing down is a flick operation (YES at Step A15), the CPU 1 performs page-turn processing of switching a page in accordance with the flick operation in its operating direction (Step A16). When the gesture operation type is a tap operation (NO at Step A15), the CPU 1 performs image selection processing of selecting an image at the tapped position (Step A17).

When the gesture operation types have not been able to be narrowed down to one based on the detection result of the gesture operation, that is, when an erroneous judgment may possibly be made if the gesture operation types are narrowed down to one based on only the detection result of the gesture operation because the detection result (operation pattern) of the gesture operation is characteristically similar to operation patterns of a plurality of gesture operation types (NO at Step A12), the CPU 1 performs a judgment by referring to “user attributes” (Step A13 to Step A15).

That is, the CPU 1 refers to the user information table 3e which includes “user attributes” of the operator specified as described above (Step A13), compares “tap judgment value” and “flick judgment value” corresponding to “user attributes” of the operator (Step A14), and then narrows down to a gesture operation type with a larger judgment value (Step A15).

Narrowing down the gesture operation types is not limited to be based on a comparison in magnitude between “tap judgment value” and “flick judgment value, but the method of the comparison is arbitrary. For example, magnitude between “tap judgment value” and “flick judgment value” may be compared by weighting these values. When the narrowed-down gesture operation type is a flick operation (YES at Step A15), the CPU 1 performs page-turn processing for switching the page in accordance with the flick operation in its operating direction (Step A16). When the gesture operation type is a tap operation (NO at Step A15), the CPU 1 performs image selection processing of selecting an image at the tapped position (Step A17).

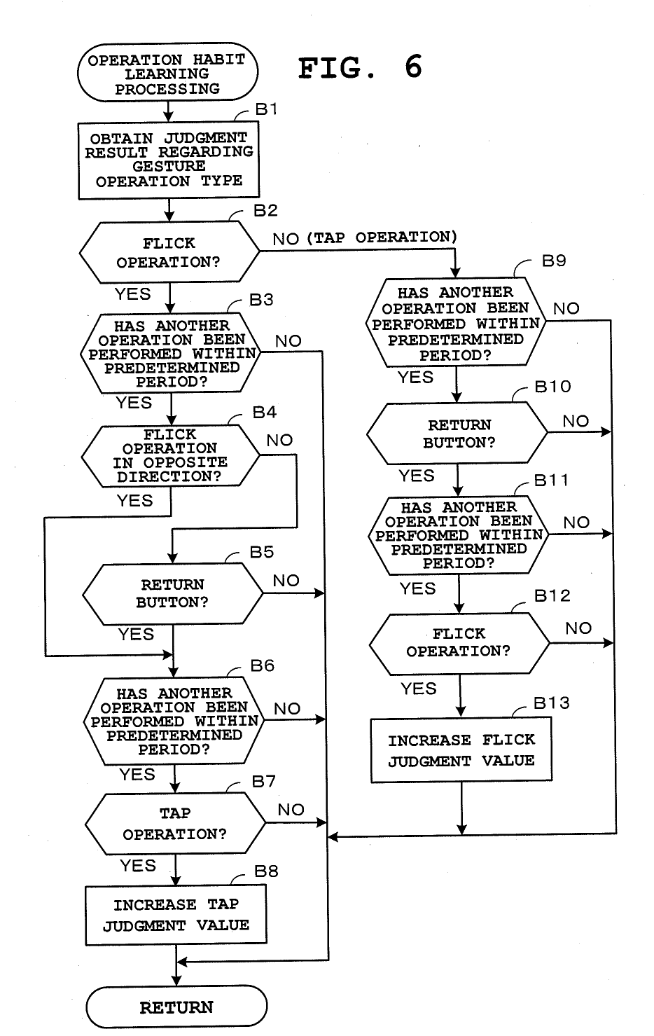

FIG. 6 is a flowchart of user's operation habit learning processing. Every time a gesture operation is performed, this flowchart is started and executed in parallel with the flowchart of FIG. 4 and FIG. 5.

First, the CPU 1 obtains the judgment result regarding gesture operation type (Step B1). When the gesture operation type is a flick operation (YES at Step B2), the CPU 1 judges whether another operation has been performed within a predetermined period (for example, within one second) after the flick operation (Step B3).

Here, if another operation has not been performed (NO at Step B3), the CPU 1 exits the flow of FIG. 6. If another operation has been performed (YES at Step B3), the CPU 1 judges whether a return operation in an opposite direction (a reverse-flick operation) has been performed (Step B4), and judges whether the return button (refer to FIG. 2) has been operated (Step B5).

Here, if neither a reverse-flick operation nor the return button operation has been performed (NO at Step B5), the CPU 1 exits the flow of FIG. 6. If either one of these operations has been performed (YES at Step B4 or YES at Step B5), the CPU 1 subsequently further judges whether another operation has been performed within a predetermined period (for example, within one second) (Step B6).

Here, if a tap operation has been performed within the predetermined period (YES at Step B7), the CPU 1 judges that the tap operation has been erroneously judged as a flick operation, and performs processing of referring to the user information table 3e which includes “user attributes” of the operator and increasing the corresponding “tap judgment value” (for example, by 0.1) (Step B8).

If another operation has not been performed within the predetermined period subsequently to a reverse-flick operation or a return button operation (NO at Step B6) or if the operation is not a tap operation (NO at Step B7), the CPU 1 exits the flow of FIG. 6. As such, if operations of a plurality of types including a return operation (a reverse-flick operation or a return button operation) have been successively performed within the predetermined period, the CPU 1 learns that the initial operation among the series of operations is recognized as an erroneously-judged operation, and the last operation is recognized as a correctly-judged operation.

If the judged gesture operation type is a tap operation (NO at Step B2), the CPU 1 judges whether another operation has been performed within a predetermined period (for example, within one second) after the tap operation (Step B9).

Here, if another operation has not been performed (NO at Step B9), the CPU 1 exits the flow of FIG. 6. If another operation has been performed (YES at Step B9), the CPU 1 judges whether the operation is a return button operation (refer to FIG. 2) (Step B10). If the operation is not a return button operation (NO at Step B10), the CPU 1 exits the flow of FIG. 6.

Here, if the return button has been operated (YES at Step B10), the CPU 1 judges whether another operation has been further performed within a predetermined period subsequently to the return button operation (Step B11). If another operation has not been performed (NO at Step B11), the CPU 1 exits the flow of FIG. 6. If another operation has been performed (YES at Step B11), the CPU 1 judges whether the operation is a flick operation (Step B12).

Here, if a flick operation has been performed subsequently to the return button operation (YES at Step B12), the CPU 1 judges that the flick operation has been erroneously judged as a tap operation, and performs processing of referring to the user information table 3e which includes “user attributes” of the operator and increasing the corresponding “flick judgment value” (for example, by 0.1) (Step B13).

Thereafter, every time a gesture operation is performed, the operation habit learning processing is repeated. As a result, the contents of the user information table 3e are updated from the initial values of “tap judgment value” and “flick judgment value”. In the example of FIG. 3B, in the males at ages 10-20, the value of “tap judgment value” is updated from “1” of the initial value to “1.6” and the value of “flick judgment value” is updated from “0” of the initial value to “0.2”, and in the females at ages over 60, the value of “tap judgment value” is updated from “0” of the initial value to “0.1” and the value of “flick judgment value” is updated from “1” of the initial value to “1.8”. As such, the operation habit becomes reflected in the judgment values.

As described above, when a gesture operation is performed, the data processing apparatus (tablet terminal device) in the present embodiment judges a gesture operation type from among a plurality of gesture operation types based on the detection result of the gesture operation and the user attributes stored in the user information table 3e, and performs processing of the type in accordance with the judged gesture operation type. As a result, when a gesture operation is detected, the gesture operation can be appropriately judged, whereby data processing in accordance with the operation can be appropriately performed. Accordingly, operability can be improved, and the user can perform an operation as intended.

When the gesture operation types have not been able to be narrowed down to one based on the detection result of the gesture operation, any one of the gesture operation types is judged in accordance with the user attributes. Accordingly, an appropriate judgment can be made as a whole. That is, when an erroneous judgment may possibly be made if the gesture operation types are narrowed down to one based on only the detection result of the gesture operation because the detection result (operation pattern) of the gesture operation is characteristically similar to operation patterns of a plurality of gesture operation types, a judgment is made by referring to the user attributes. Accordingly, an appropriate judgment can be made as a whole.

The user information table 3e stores therein judgment values for respective gesture operation types corresponding to the user attributes indicating whether a judgment is made with priority. The CPU 1 compares the judgment values for the respective gesture operation types and thereby judges any one of the gesture operation types. Accordingly, the gesture operation types can be narrowed down by various methods such as comparing the magnitudes of the judgment values.

The CPU 1 stores a plurality of items such as gender and an age group, as user attributes. Accordingly, the attributes of the user can be more specifically set, and the gesture operation type can be appropriately judged in accordance with the user attributes.

The CPU 1 learns the operation habit of the operator regarding the gesture operation, and stores the operation habit as a user attribute. Accordingly, the user's operation habit can be considered when the gesture operation type is judged, whereby a more appropriate judgment can be made.

When operations of a plurality of types including a return operation are successively performed within a predetermined period, the CPU 1 recognizes the initial operation among the series of operations as an erroneously-judged operation and recognizes the last operation as a correctly-judged operation. Accordingly, the operation habit can be appropriately learnt.

The CPU 1 identifies the user performing the gesture operation, and judges the gesture operation type based on the user attribute. Accordingly, even in an environment where a plurality of users share the tablet terminal device for use, the tablet terminal device can corresponds to the gesture operation of each user.

The CPU 1 judges the gesture operation type in accordance with the detection result obtained by detecting the operation on the touch display section 6. Accordingly, the gesture operation performed on the touch display section 6 can be judged.

The CPU 1 judges either one of a tap operation and a flick operation as the gesture operation type on the touch display section 6. Accordingly, a tap operation and a flick operation similar to each other can be appropriately judged.

In the above-described embodiment, the user information table 3e stores therein the values of “tap judgment value” and “flick judgment value” for the user attributes (gender and the age group). Alternatively, values of “tap judgment value” and “flick judgment value” corresponding to the gender may be stored, and values of “tap judgment value” and “flick judgment value” corresponding to the age group may be stored.

In this case, the gesture operation type may be judged by weighting the above-described values in accordance with whether the gender or age group is valued. For example, the gesture operation type may be judged by the following method: a total value of the weighted value of “tap judgment values” for the gender and the weighted value of “tap judgment values” for the age group is calculated. Similarly, a total value of the weighted value of “flick judgment values” for the gender and the value of weighted “flick judgment values” for the age group is calculated. And then, these total values are compared with each other.

In the above-described embodiment, either one of a tap operation and a flick operation is judged as the gesture operation type. Alternatively, other than the tap operation and the flick operation, for example, a contact and moving operation (slide operation or drag operation), an operation of fixing and keeping a contact position (hold operation), an operation of making contact with a plurality of display positions simultaneously with a plurality of fingers (double-tap operation), an operation of instructing to enlarge display data (pinch-out operation), an operation of instructing to reduce display data (pinch-in operation), may be judged as the gesture operation type.

In the above-described embodiment, a plurality of items of the gender and the age group are stored as the user attributes. Alternatively, an item of a health condition of the user (such as disability of the body) may be included in the user attributes.

In the above-described embodiment, when operations of a plurality of types including a return operation are successively performed within a predetermined period, the initial operation among the series of operations is recognized as an erroneously-judged operation, and the last operation is learnt as a correctly-judged operation. Conversely, when operations of a plurality of types including a return operation are successively performed within a predetermined period, the last operation among the series of operations may be recognized as a correctly-judged operation, and the initial operation may be learnt as an erroneously-judged operation.

In the above-described embodiment, the gesture operation on the touch display section 6 is detected. Alternatively, an imaging device which captures an image of a hand movement or a body movement of the user may be used. That is, an imaging section may be used as a section which detects the gesture operation. As a result, many gesture operations can be detected.

Furthermore, in the above-described embodiment, the present invention has been applied to a tablet terminal device as a data processing apparatus. However, the present invention is not limited thereto, and may be applied to a personal computer, a PDA (Personal Digital Assistant), a portable phone, a digital camera, a music player, or the like as a data processing apparatus.

Still further, the “devices” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. A data processing apparatus which detects a gesture operation, the apparatus comprising:
an attribute storage section which stores an attribute of a user;
a detecting section which detects an operation content of the gesture operation;
a judging section which judges, when the gesture operation is performed, a type of the gesture operation performed from among a plurality of gesture operation types based on a detection result of the operation content detected by the detecting section and the user attribute stored in the attribute storage section; and
a data processing section which performs processing of a type in accordance with the gesture operation type judged by the judging section.

2. The data processing apparatus according to claim 1, wherein the judging section judges any one of the gesture operation types in accordance with the user attribute when the gesture operation types have not been able to be narrowed down to one based on the detection result of the detecting section.

3. The data processing apparatus according to claim 1,
wherein the attribute storage section stores judgment values indicating whether a judgment is made with priority, for respective gesture operation types corresponding to the user attribute, and
wherein the judging section judges any one of the gesture operation types by comparing the judgment values for the respective gesture operation types.

4. The data processing apparatus according to claim 1, wherein the attribute storage section stores a plurality of items at least among gender, an age group, and a health condition of the user as the user attribute.

5. The data processing apparatus according to claim 1, further comprising an operation habit learning section which learns an operation habit of the gesture operation,
wherein the attribute storage section stores the operation habit obtained by the operation habit learning section as the user attribute.

6. The data processing apparatus according to claim 5, wherein the operation habit learning section learns, when operations of a plurality of types including a return operation are successively performed within a predetermined period, an initial operation among the operations as an erroneously-judged operation or learns a last operation as a correctly-judged operation.

7. The data processing apparatus according to claim 1, further comprising an identifying section which identifies a user performing the gesture operation detected by the detecting section,
wherein the judging section judges the gesture operation type based on an attribute of the user identified by the identifying section.

8. The data processing apparatus according to claim 1, wherein the detecting section detects the operation content of the gesture operation performed on a display screen or the gesture operation obtained from a captured image of the user captured by an imaging section.

9. The data processing apparatus according to claim 8, wherein the judging section judges either one of a tap operation and a flick operation as the gesture operation type performed on the display screen.

10. A method in a data processing apparatus which detects a gesture operation, the method comprising:
a managing step of storing and managing an attribute of a user in a storage section;
a detecting step of detecting an operation content of the gesture operation;
a judging step of judging, when the gesture operation is performed, a type of the gesture operation performed from among a plurality of gesture operation types based on the detection result of the operation content detected in the detecting step and the user attribute stored in the storage section; and
a performing step of performing processing of a type in accordance with the judged gesture operation type.
